(19) United States
(12) Patent Application Publication
(10) Pub. No.: US 2024/0338593 A1
(43) Pub. Date: Oct. 10, 2024

(54) MACHINE LEARNING MODEL OPTIMIZATION

(71) Applicant: Etsy, Inc., Brooklyn, NY (US)

(72) Inventor: Zichang Long, Brooklyn, NY (US)

(21) Appl. No.: 18/132,710

(22) Filed: Apr. 10, 2023

(51) Int. Cl. G06N 20/00

(52) U.S. Cl. CPC G06N 20/00

(57) ABSTRACT

Methods, systems, and apparatus, including computer programs encoded on computer-storage media, for optimizing a machine learning model. In some implementations, a method includes performing, during the model training process, model training for the machine learning model using training data; in response to performing the model training, generating a temporary deployment of the machine learning model; providing, as input to the temporarily deployed machine learning model, a portion of the training data including one or more elements; obtaining, based on processing of the portion of the training data by the temporarily deployed machine learning model, response data indicating output of the temporarily deployed machine learning model; determining a latency value indicating a processing time for the temporarily deployed machine learning model to generate the response data; and optimizing the machine learning model using the latency value.

### FIELD

This specification generally relates to optimizing machine learning models based on the latency evaluations of the machine learning model during model training.

### BACKGROUND

Machine learning model processing can be resource intensive. For example, websites that provide user interactions with machine learning models must provide sufficient computing resources for receiving input data, processing that data, and providing output back to the user. The process requirements can grow exponentially with additional machine learning models running simultaneously and increased usage. Carbon emissions related to powering such intensive computations is seen as a significant driver of climate change for the industry.

### SUMMARY

This specification generally relates to improving efficiencies of machine learning models, such as models that provide results or predictions for users navigating a webpage.

One innovative aspect of the subject matter described in this specification is embodied in a method that includes performing, during the model training process, model training for the machine learning model using training data; in response to performing the model training, generating a temporary deployment of the machine learning model; providing, as input to the temporarily deployed machine learning model, a portion of the training data including one or more elements; obtaining, based on processing of the portion of the training data by the temporarily deployed machine learning model, response data indicating output of the temporarily deployed machine learning model; determining a latency value indicating a processing time for the temporarily deployed machine learning model to generate the response data; and optimizing the machine learning model using the latency value.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, optimizing the machine learning model using the latency value includes: adjusting one or more of an amount of features, quantization of feature values, or a number of processing layers.

In some implementations, providing, as input to the temporarily deployed machine learning model, the portion of the training data includes: generating the training data as a set of serialized machine readable input in a format supported by the temporarily deployed machine learning model.

In some implementations, actions include performing evaluation of the machine learning model subsequent to optimizing the machine learning model using the latency value. In some implementations, performing the evaluation of the machine learning model includes: performing (i) accuracy evaluation on the machine learning model, including generating one or more model performance metrics, and (ii) latency evaluation on the machine learning model. In some implementations, performing latency evaluation on the machine learning model includes: performing latency evaluation on the machine learning model within a processing framework that includes an interface for website input or output and data retrieval from one or more data sources communicably connected to one or more computers operating a website.

In some implementations, determining the latency value indicating the processing time for the temporarily deployed machine learning model to generate the response data includes: determining one or more values each indicating a processing time required by the temporarily deployed machine learning model to process an element of the one or more elements of the training data; generating a distribution from the one or more values each indicating a processing time; and determining the latency value as a percentile of the distribution.

In some implementations, the percentile includes the 99th percentile of the distribution. In some implementations, optimizing the machine learning model using the latency value includes: comparing the latency value as the percentile of the distribution to a threshold latency; determining that the latency value satisfies the threshold latency; and in response to determining that the latency value satisfies the threshold latency, optimizing the machine learning model using the latency value. In some implementations, the threshold latency is adjustable by a user. In some implementations, the threshold latency is less than or equal to 100 milliseconds.

In some implementations, optimizing the machine learning model using the latency value includes: providing a user interface that (i) visualizes the latency value on a display of a user device and (ii) accepts input from a user to adjust one or more features of the machine learning model. In some implementations, the machine learning model is configured to provide a ranked list of search output based on a user query.

Advantageous implementations can include one or more of the following features. In general, latency evaluations of one or more machine learning models allows for optimization of the one or more machine learning models. The optimized one or more machine learning models can generate results with less processing required by an operating computer, less energy, and greater accuracy than un-optimized models, e.g., preventing inaccurate or non-responses by reducing processing time and allowing all requests to be responded to within bandwidth or other resource limitations. Optimized models can reduce carbon emissions related to powering such related computations and help to reduce climate change.

Latency evaluations of the one or more machine learning models as they operate in a small framework, as opposed to a larger framework, e.g., on a hosted website, allow testing to be performed more rapidly and corresponding feedback to be incorporated as adjustments into the one or more machine learning models. In some implementations, a smaller framework for operating a machine learning model for latency evaluation includes a subset of elements included in a larger framework. For example, a larger framework can include a web front page element and a feature retrieval layer. A smaller framework cannot include a web front page element and a feature retrieval layer.

In some implementations, a larger framework tests the latency for an entire technology stack, e.g., from website to a machine learning model and back to the website. This can make a larger framework more process intensive because more components need to be implemented before the larger framework is able to be used for latency evaluation of one or more machine learning models. For example, if a new machine learning model requires a new feature, e.g., feature A corresponding to input data for the model, and there does not exist a component within the current implementation of a larger framework to retrieve the new feature, then this component must first be developed in the larger framework before the larger framework can be used to conduct latency evaluations. The smaller framework can evaluate only the latency contribution of the machine learning model and not the rest of the technology stack. The smaller framework can use pre-existing training data without requiring new component development.

The techniques described herein use a smaller framework to evaluate latency, in part, to optimize one or more machine learning models. In some implementations, subsequent latency evaluation is performed on the optimized models within a larger framework. Accuracy can be included in subsequent testing of the optimized models within a larger framework.

In general, larger frameworks require more preparation for resource gathering and provisioning of computer systems to perform the corresponding processes. By performing latency evaluation using a smaller framework around a given machine learning model to be tested, less time is needed to prepare and execute the latency testing. Latency evaluation based model optimizations help improve a service's processing performance (e.g., by reducing a response time of the model as integrated in the larger framework of the service), which in turn increases user engagement in the service by helping prevent a user from navigating away from the service due to delay in processing of a request submitted by a user device to the service. Traditionally, latency evaluations are performed for a trained and deployed model integrated in a processing environment, e.g., hosted on website, embedded in application, among others, where end-to-end latency is evaluated after the model has been deployed. The techniques described herein allow for early identification of latency based issues that are tied to effects stemming from the model, e.g., instead of other aspects of the overall implementation, and for such latency testing to be performed on the model- and prior to full deployment and integration of the model as part of the service and larger framework.

Using a smaller framework allows for the use of the same data as used for training to be reused for latency evaluation, e.g., because the smaller framework does not change required input compared to input for training or does not require resources from multiple other data sources, such as data resources used for a hosted webpage. By using the same data, data storage requirements can be reduced and, if performed using one or more systems that share a storage device storing the training data, the execution time of training and latency evaluation can be reduced by, at least, reducing a second execution of obtaining the training data. The same data can be used for both training and executing latency evaluations.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for optimizing a machine learning model.

FIG. 2A is a diagram showing an example of processing differences between a process without additional latency optimization and a process with additional latency optimization for optimizing a machine learning model.

FIG. 2B is a diagram showing an example of processing improvements after optimization of a machine learning model.

FIG. 3 is a flow diagram illustrating an example of a process for optimizing a machine learning model.

FIG. 4 is a diagram illustrating an example of a computing system used for optimizing a machine learning model.

Like reference numbers and designations in the various drawings indicate like elements.

### DETAILED DESCRIPTION

In general, techniques described herein include using temporarily deployed models to evaluate latency of machine learning models. A serialized version of training data can be provided to the temporarily deployed model to generate latency values used to optimize the model temporarily deployed. The training data can be used to initially or subsequently train the deployed model, e.g., before the model is deployed in a framework for a service scenario. After optimization, the model can be a compressed version of a previous model or otherwise decrease processing requirements or processing time compared to an initial un-optimized model. Such optimization can reduce energy use for implementing computers and corresponding carbon emissions. Optimization can further reduce user wait times in service scenarios that provide predictions from an optimized model.

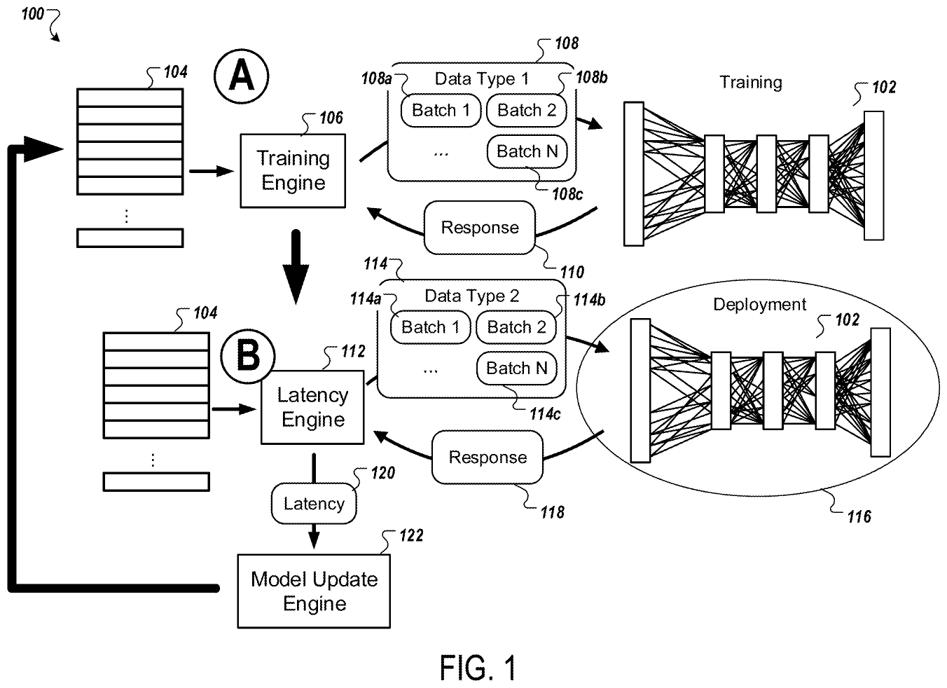

FIG. 1 is a diagram showing an example of a system 100 for optimizing a machine learning model 102. In some implementations, the system 100 is used to generate latency values to inform subsequent adjustments to the machine learning model 102. For example, the system 100 can determine latency values representing durations of time that the machine learning model 102 takes to process data. The system 100 can be used to generate an optimized machine learning network that is more efficient, e.g., provides process output quicker or consumes fewer processing resources compared to un-optimized models. The system 100 can help reduce processing requirements and reduce corresponding energy use and associated carbon emissions. The system 100 can provide a trained version of the machine learning model 102 for deployment, e.g., on a website or user device.

The system 100 includes a training engine 106, a latency engine 112, and a model update engine 122. In general, an engine includes a set of programming instructions executable by a processor. The execution of a set of instructions represent operations described in regard to the engines. The engines of FIG. 1 can be operated by one or more computer processors physically or communicably connected to one another. In general, the training engine 106 trains the model 102 and the latency engine 112 generates a latency value 120 for the model update engine 122. The model update engine 122 can then update the model 102 using the latency value 120. The update can optimize the model 102 to reduce processing requirements for operating the model 102 or reduce the amount of delay between providing input data and obtaining output data from the model 102.

In stage A, the training engine 106 obtains input data 104. The training engine 106 uses the input data 104 to train the model 102. In some implementations, the training engine 106 parses the input data 104 into one or more batches. For example, the training engine 106 can group together one or more elements, e.g., elements indicating a user or corresponding data, of the input data 104 into a first batch 108a. The one or more elements can include data representing a request for output from the model 102, such as an actual request stored from a user device, e.g., a query received from the user device or a request generated by a component of the system 100, e.g., the training engine 106. A request can include, for example, a prediction for type of clothing article to display to a user device on a webpage where the input data for generating such a prediction can include one or more features, such as, e.g., age of a user, gender, location, device used, browsing history, among others.

In some implementations, the training engine 106 generates training data 108. The training engine 106 can provide portions of the training data 108 to the model 102 to iteratively adjust one or more weights or parameters of the model 102. Training algorithms, such as gradient descent based algorithms, among others, can be used to determine values of one or more weights or parameters of the model 102.

In some implementations, the input data 104 is represented in a particular format, e.g., JSON. The input data 104 can be in a format that is stored by a webpage that hosts or will host the model 102 for performing one or more processes for user queries. In some implementations, the training data 108 is different than the input data 104. For example, the training data 108 can be a serialized version of the input data 104. The training engine 106 can obtain the input data 104 and serialize elements of the input data 104 to generate training data 108 of a first type. The type of the serialized data can be generated to conform to a data format for which the model 102 is configured to obtain as input.

In some implementations, the training engine 106 provides the training data 108 to a cloud storage device. For example, the training engine 106 can generate the training data 108 and then provide the generated training data 108 to one or more storage devices communicably connected to the training engine 106. The training engine 106, or another one or more processors configured to train models, can access the storage devices, obtain the training data 108, and perform training of models using the training data 108. In the example of FIG. 1, the training engine 106 is described as generating the training data 108 and training the model 102.

In some implementations, one or more processors configured to generate the training data 108 are different from one or more processors that use the training data 108 to train the model 102. For example, one or more processors can generate the training data 108 and provide the training data 108 to at least one storage device. One or more other processors can obtain the training data 108 from the at least one storage device and train one or more models using the training data 108.

In the example of FIG. 1, the training engine 106 trains the model 102. In some implementations, the training engine 106 provides the training data 108 to the model 102 as input. For example, the training engine 106 can provide the batches of data formatted in a first data type 108a-c to the model 102. The model 102 can process one or more of the batches 108a-c and provide output to the training engine 106 as a response 110. The response 110 can include a prediction or other data representing output of one or more processes of the model 102 processing one or more of the batches 108a-c. In one example case, the response 110 can include an indication of an article of clothing to be shown to a user based on data indicative of the user included in the training data 108.

In some implementations, the training data 108 includes ground truth data. For example, the training engine 106 can compare a portion of the training data 108 corresponding to ground truth with data of the response 110. The ground truth portion of the training data 108 can indicate an accurate or observed result corresponding to a portion of the training data 108 used as input to generate the response 110. The training engine 106 can determine one or more error terms representing a difference between the ground truth of the training data 108 and the data of the response 110. Using the one or more error terms, the training engine 106 can adjust one or more weights or parameters of the model 102. By adjusting the one or more weights or parameters of the model 102, the training engine 106 can reduce one or more error terms in subsequent error term calculations. In some implementations, training techniques, such as gradient descent based training techniques, are used by the training engine 106 to train the model 102.

In stage B, the latency engine 112 determines a latency value 120, e.g., one or more values indicating, at least, an amount of processing time needed by the model 102 to generate the response 118 based on the provided data 114. In some implementations, after one or more iterations of training by the training engine 106, the model 102 is provided to the latency engine 112 for latency based optimization. For example, the latency engine 112 can provide data 114, similar to that which the training engine 106 provides to the model 102, to generate a response 118.

In this case, the latency engine 112 is determining a latency that represents an amount of processing time needed by the model 102 to generate the response 118. In some implementations, the model 102 is provided to the latency engine 112 for latency based optimization before a first iteration of training by the training engine 106. For example, the latency engine 112 can generate a latency value for a model that has been randomly initiated with one or more weights or parameters.

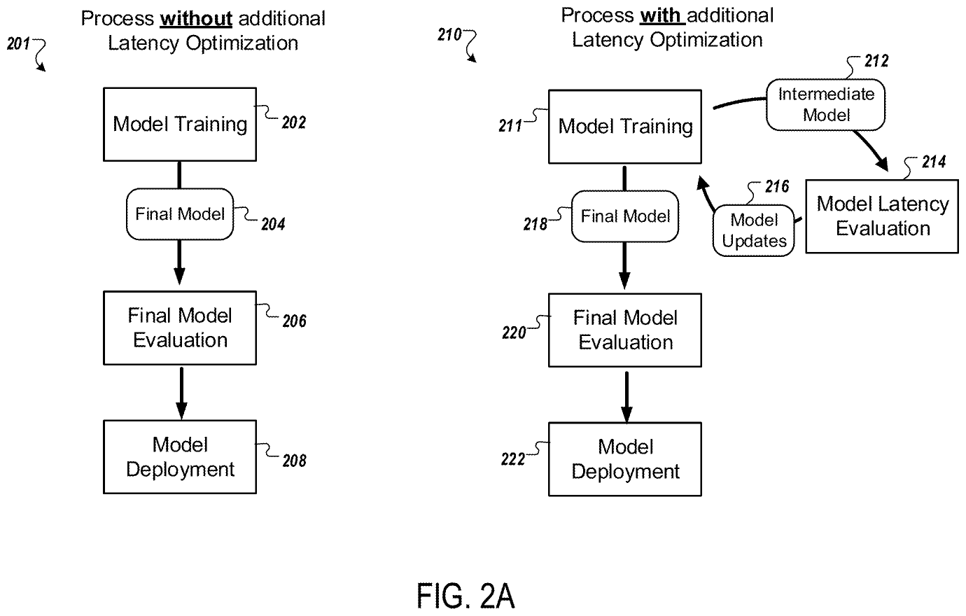

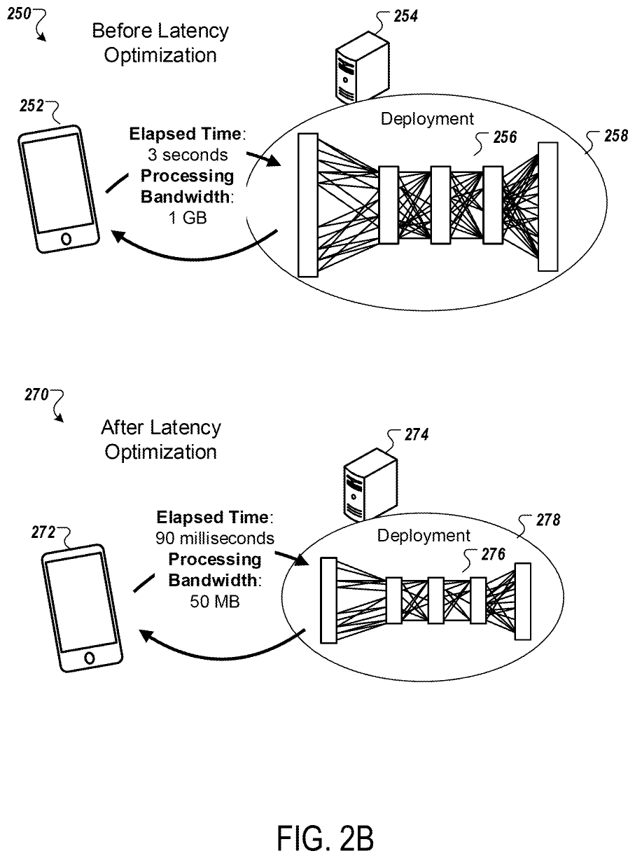

In some implementations, techniques described herein are used to evaluate model latency at any pre-final model deployment stage. For example, the latency engine 112 can evaluate the model 102 after evaluation, e.g., final model evaluation 220 in FIG. 2A, or before training by the training engine 106. In general, latency evaluation, e.g., by the latency engine 112, need not be immediately preceded by model training, e.g., by the training engine 106.

In some implementations, the model 102 is hosted in a deployment environment 116. For example, the latency engine 112 can include one or more processors that host the model 102 in a serving framework, e.g., TensorFlow, among others. The latency engine 112 can include one or more processors configured to serialize and send data to the deployed model 102. In some implementations, the latency engine 112 can serialize the input data 104 corresponding to the training data 108 to generate the latency training data 114. For example, the latency engine 112 need not generate new data or obtain data from other data sources. Instead, the latency engine 112 can obtain the input data 104 from the training engine 106 or a storage device communicably connected to the training engine 106. In some implementations, the deployment environment 116 includes an application programming interface for the deployed model 102. In some implementations, the format of input data supported by the deployed model 102 is the format supported by the application programming interface of the deployment environment 116.

In some implementations, the latency engine 112 generates the latency training data 114 into a particular type supported by the deployed model 102. For example, the latency engine 112 can generate the latency training data 114 into TensorProtos, among other types. In some implementations, the latency engine 112 provides a portion of the input data 104 as the latency training data 114 to the deployed model 102. For example, only a portion of the input data 104 need be used to generate a substantially accurate latency value 120. In some implementations, 1000 data samples are used by the latency engine 112 to converge on one or more stable values to include in the latency value 120. In some implementations, the latency engine 112 compares one or more latency values generated to determine a stability of the latency values. After determining the latency values are stable, the latency engine 112 can generate and output the latency value 120.

In some implementations, the latency engine 112 generates the latency training data 114 using one or more schemas. For example, the latency engine 112 can use a schema.pbtxt file to serialize the input data 104 to generate the latency training data 114.

The latency engine 112 provides the latency training data 114 to the deployed model 102. In some implementations, the latency training data 114 is in a different format compared to the training data 108 used by the training engine 106. For example, the format of the latency training data 114 can match an expected format for the deployment environment 116 hosting the deployed model 102. The format of the training data 108 can match an expected format for input to the model 102 while not deployed.

In some implementations, the latency training data 114 includes one or more batches of data. For example, the latency engine 112 can parse the input data 104 and generate one or more batches 114a-c. In some cases, the batches can be similar to the batches 108a-c, e.g., include the same features or number of elements. The batches 114a-c can include one or more elements of the input data 104 grouped into a single input data set provided to the deployed model 102. An element of the input data 104 can indicate data of a particular user. The latency engine 112 can combine a certain number, e.g., 10, of elements corresponding to that number of users indicated in the input data 104 to generate one or more of the batches 114a-c. For an input data 104 that includes 100 elements, the latency engine 112 can generate 10 batches of 10 elements each and provide batches of those 10 elements to the deployed model 102 for latency training.

The latency engine 112 receives the response 118 from the deployed model 102 in response to providing the latency training data 114. The latency engine 112 generates the latency value 120 using the response 118. For example, the response 118 can indicate a prediction generated by the deployed model 102 based on a portion of the latency training data 114 provided by the latency engine 112. In some implementations, the latency engine 112 can determine when the response 118 was received and compare a timestamp indicating the time of receipt to a timestamp indicating the time the latency engine 112 provided a corresponding portion of the latency training data 114 used to generate data of the response 118.

In some implementations, the latency engine 112 obtains multiple responses from the deployed model 102 and determines the latency value 120 using the multiple responses. For example, the latency engine 112 can provide portions of the latency training data 114 to the deployed model 102. The latency engine 112 can obtain response data indicating predictions or other output from the deployed model processing the provided portions of the latency training data 114. The latency engine 112 can determine the latency value 120 using a cumulative measurement of one or more latency measurements determined by the latency engine 112 using responses from the deployed model 102, e.g., determining the latency value 120 as a duration from sending a batch of 10 items provided to the model 102 as input and receiving 10 outputs in response from the model 102 as a batch or incrementally.

In some implementations, the latency engine 112 determines if a latency value satisfies a threshold. For example, the latency engine 112 can determine if a latency value generated by the latency engine 112 satisfies a threshold latency time of 100 milliseconds (ms). In some implementations, the latency engine 112 determines a distribution of latency times based on providing multiple portions of the latency training data 114 to the deployed model 102. The latency engine 112 can determine a particular percentile of the distribution as the latency value 120, e.g., 95th percentile, 99th percentile, among others. The latency engine 112 can determine if the latency value 120 representing a percentile latency measurement satisfies (e.g., is less than, less than or equal to, among others) a threshold value. For example, the latency engine 112 can determine the 99th percentile as the percentile for the latency value 120. The latency engine 112 can determine, using the determined 99th percentile, if 99 percent of the latencies generated from output of the deployed model 102 satisfy one or more thresholds, e.g., 100 ms, 200 ms, 30-40 ms, among others. A given threshold can vary, e.g., based on a type of system such as distributed cloud machine learning models, among others. In general, different system types can accept different amounts of latency. Thresholds of the latency engine 112 can reflect what system a given tested model will be used on, e.g., the latency engine 112 can use a corresponding threshold that is higher if the system does not have to provide feedback as fast as another type of system and lower if a corresponding system does have to provide feedback faster than another type of system when deployed. The value for which 99 percent of latencies generated from output of the deployed model 102 fall within, e.g., inclusive or exclusive, <or =97.3 ms or other value, <98.2 ms or other value, can be included in the latency value 120.

The latency engine 112 provides the latency value 120 to the model update engine 122. The model update engine 122 can adjust one or more weights or parameters of the model 102 using the latency value 120. For example, if the latency value 120 is above one or more thresholds, e.g., a percentile threshold based on a distribution of latency measurements generated by the latency engine 112, the model update engine 122 can adjust the model 102 to reduce latency. In some implementations, the model update engine 122 can reduce latency by reducing features processed, processing of features, layers of processing, among other compression methods.

In some implementations, the model update engine 122 includes a display element to provide a user of the system 100 with a determination of latency of the deployed model 102. For example, the model update engine 122 can provide the latency value 120 to a display of a user device. The latency value 120 can include an indication of one or more latencies for the deployed model 102, e.g., a latency in initial processing of input data, a latency in providing results, a latency in a particular layer or section of the model, a latency corresponding to specific features of the input data. The latency value 120 can be used by the model update engine 122 to generate suggestions for a user to consider in updating the model 102. The model update engine 122 can use heuristics or a model-based system to provide recommendations for types of adjustments that a model trainer can put into effect. As discussed, the model update engine 122 can also provide automatic updates to the model 102 to reduce latency or, if already satisfying a latency threshold, increase latency, e.g., to regain robustness or improve accuracy in operation.

The training engine 106, the latency engine 112, and the model update engine 122 can continue evaluating and updating the model 102 until they generate a final model that is an optimal model, e.g., satisfies one or more performance thresholds. The final model can be further evaluated within a deployment framework that includes other parameters that may affect latency, e.g., due to network delays, among others. The final model can be deployed on a webpage or user device to provide predictions or other output based on user input.

FIG. 2A is a diagram showing an example of processing differences between a process 201 without additional latency optimization and a process 210 with additional latency optimization for optimizing a machine learning model. The process 210 can generate a model that is more efficient and can do so more quickly than the process 201. In the process 201, model training 202 generates a final model 204 that is provided for final model evaluation 206. The final model 204 either passes or fails the final model evaluation 206. After passing, the final model 204 can be used in deployment 208. After failing, the final model 204 can be further adjusted to meet the requirements of the final model evaluation 206. By performing the evaluation only after the final model 204 is generated, the process 201 is not as efficient as the process 210 because changes to the model can be made only at the final stage, i.e., after numerous time and computing resources have been expended in deploying and evaluating the model, which may be determined to be a non-performant model due to latency issues in this model.

In contrast, the process 210 provides for updates based on latency before a final model 218 is provided for evaluation. The updates based on latency can improve the efficiency of the corresponding final model 218 of the process 210 compared to the final model 204 of the process 201. In addition, the process 210 can help identify structural or other problems in a given model earlier in development. The process 210 can be used to optimize a model without a surrounding application—e.g., user facing interface, webpage, mobile application, among others-completed or initialized as the model latency evaluation 214 and optimization can be performed on a smaller deployment framework—e.g., TensorFlow, among others-without requiring preparation of features or data for the surrounding application to evaluate the model.

In the process 210, the model training 211 works together with the model latency evaluation 214 to generate the final model 218, similar to the training engine 106 and the latency engine 112 of FIG. 1. The model latency evaluation 214 can generate updates 216 to a given intermediate model 212, such as the model 102. The final model 218 can be generated based, in part, on the updates 216 generated by the model latency evaluation 214.

In some implementations, the final model evaluation 220 includes a latency evaluation based on how long processing by the final model 218 takes including other latency effects of the model, e.g., framework latency, such as latency from network input/output operations, data retrieval latency, website latency, among others. Testing other latencies may be crucial for deployment but, for optimizing a model, the extra testing can be unnecessarily time consuming and can even cause corresponding latency optimization to be inaccurate by masking latency caused exclusively by elements of a machine learning model. By performing the model latency evaluation 214 and using output of the model latency evaluation 214 to update the model 212, the final model 218 is more likely to pass the final model evaluation 220 and be used for deployment 222. In this way, the process 210 can decrease development time for generating models for deployment based on early use of latency metrics to adjust a given model to satisfy one or more latency thresholds, such as a percentile based latency metric.

FIG. 2B is a diagram showing an example of processing improvements after optimization of a machine learning model. For example, process 250 shows a user device 252 interacting with a server 254 that is hosting a model 256 in a framework 258. The user device 252 is requesting a prediction or other output from the model 256. The user device 252 provides input data and receives output data. The operations take 3 seconds and use a processing bandwidth of 1 gigabyte. Delays and extensive processing usage can be attributed to multiple factors. In general: the more data a model requires, the more latency the model displays when providing output; reduction in input data, including input features, can reduce latency of a model and corresponding processing requirements; the amount of layers for processing in a model can be proportional to the amount of latency or processing requirements of the model; the extent of parameter quantization, e.g., reducing the data size of individual input values or weights or parameters of the model, can vary inversely with latency and processing requirements of the model. The model 256 displays a greater latency and requires more processing power compared to model 276 shown in process 270.

The process 270 shows a user device 272 interacting with a server 274 that is hosting a model 276 in a framework 278. The user device 272 is requesting a prediction or other output from the model 276, similar to the user device 252. The user device 272 provides input data and receives output data. The operations take less time and use less processing power compared to the processes of the model 256 in the process 250. The operations of the model 276 in the process 270 take 90 milliseconds and consume 50 megabytes of processing resources.

The model 276 is, effectively, an optimized version of the model 256 generated using the latency optimization training techniques described herein. The model 276 is adjusted based on latency values generated after one or more iterations of training. An intermediate form of the model 276 can be adjusted to produce a final version of the model 276 that displays low levels of latency and consumes less processing resources compared to non-latency optimized models. The process of generating such a model can be quicker as well in terms of development time by reducing adjustments to model after final evaluation. Latency optimization as described herein can help reduce the repetitive building of specific testing architectures that obtain input data from one or more data sources specifically to test a given final model. Instead, latency testing and adjustment, as described in regard to the latency engine 112 of FIG. 1, can use the same input data as input data used for training, e.g., input data 104 can be the same as the input data 104 used for iterations of training a model, such as the model 102 in FIG. 1.

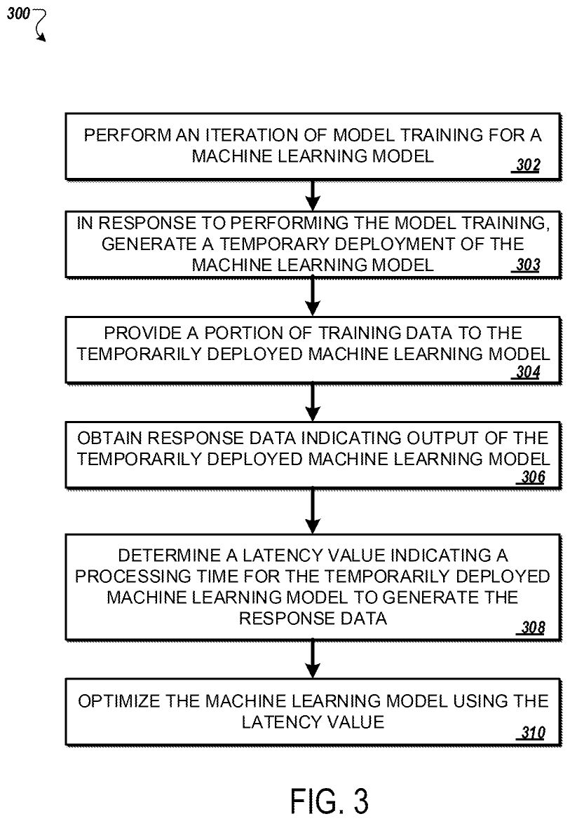

FIG. 3 is a flow diagram illustrating an example of a process 300 for optimizing a machine learning model and in particular, for evaluating latency of a machine learning model during the model training process. The process 300 may be performed by one or more electronic systems, for example, the system 100 of FIG. 1. Operations of the process 300 are described below for illustration purposes only. Operations of the process 300 can be performed by any appropriate device or system, e.g., any appropriate data processing apparatus. Operations of the process 300 can also be implemented as instructions stored on a computer readable medium, which may be non-transitory. Execution of the instructions causes one or more data processing apparatus to perform operations of the process 300. Each of the steps of process 300 are described in reference to the figures of this application, e.g., FIGS. 1, 2A-2B, and 4, and are incorporated within the description of FIG. 3 by reference.

The process 300 includes performing an iteration of model training for a machine learning model (302). For example, the training engine 106 of FIG. 1 can perform one or more iterations of training on the model 102. The training engine 106 of FIG. 1 can perform a partial iteration. In some implementations, step 302 is not performed before latency evaluation for a given model, e.g., the model 102 of FIG. 1. The model 102 can be evaluated for latency before one or more iterations of training.

The process 300 includes in response to performing the model training, generating a temporary deployment of the machine learning model (303). For example, the latency engine 112 or another element of the system 100 can generate the deployment environment 116, which can include a deployment framework for the model 102. In some implementations, the deployment environment 116 includes a serving framework, e.g., TensorFlow, among others.

The process 300 includes providing a portion of training data to the temporarily deployed machine learning model (304). For example, the latency engine 112 of FIG. 1 can provide the latency training data 114, e.g., as input to the temporarily deployed machine learning model, to the deployed model 102. In some implementations, providing a portion of training data to the temporarily deployed machine learning model includes generating the training data as a set of serialized machine readable input in a format supported by the trained machine learning model. For example, the model 102 can be temporarily deployed in a TensorFlow deployment environment. The latency engine 112 can generate data of a format that matches a format acceptable by the model 102 or the TensorFlow deployment environment and provide that data to the temporarily deployed machine learning model.

The process 300 includes obtaining response data indicating output of the temporarily deployed machine learning model processing the portion of training data (306). For example, the latency engine 112 of FIG. 1 can receive the response 118 after providing the latency training data 114 to the deployed model 102. The response 118 can be based on processing of the portion of the training data by the temporarily deployed machine learning model.

The process 300 includes determining a latency value indicating a processing time for the temporarily deployed machine learning model to generate the response data (308). For example, the latency engine 112 of FIG. 1 can determine the latency value 120 using the response 118. In some implementations, the latency value 120 is a percentile measurement indicating a duration of time within which, e.g., less than or less than or equal to, a specific percentage of output from the model 102 is generated by the model 102. For example, if 99 out of 100 responses generated by the model 102 are generated within 98.2 ms, the latency engine 112 can determine that the latency value 120 includes the value 98.2 ms. In some implementations, each latency response is based on the model 102 processing a batch of the batches 114a-c.

In some implementations, determining, e.g., by the latency engine 112, the latency value indicating the processing time for the temporarily deployed machine learning model to generate the response data includes determining one or more values each indicating a processing time required by the temporarily deployed machine learning model to process an element of the one or more elements of the training data, generating a distribution from the one or more values each indicating a processing time; and determining the latency value as a percentile of the distribution. In some implementations, the percentile is the 99^{th} percentile of the distribution.

The process 300 includes optimizing the trained machine learning model using the latency value (310). For example, the model update engine 122 can directly update the model 102 to optimize the model 102 for latency minimization or other criteria. In some implementations, the model update engine 122 provides data to a user device. For example, the user device can display one or more latency values to a user. The user can then adjust one or more features of the model 102 using the indication of one or more latency values provided by the model update engine 122 to the user device. One or more weights or parameters of the model 102 can be adjusted by a backpropagation algorithm, e.g., operated by the training engine 106 or other element of the system 100.

In some implementations, the process 300 includes optimizing the trained machine learning model using other values. For example, instead of latency, or in addition to latency, the process 300 can include determining other values based on, e.g., obtaining response data indicating output of the temporarily deployed machine learning model. One or more computer processors implementing the process 300 can determine values, such as machine learning model efficiency, efficacy, ethical measures, meta analyses, among others. Using the determined values, the one or more computer processors, e.g., using the model update engine 122, can update a model, e.g., the model 102. In some implementations, the one or more computer processors update one or more models based on one or more of the determined values satisfying a threshold. For example, if a value satisfies a threshold, e.g., is above a predetermined value, the one or more computer processors can adjust one or more weights or parameters of one or more models or provide feedback to a user indicating one or more of the determined values or suggested adjustments.

In some implementations, the process 300 includes performing evaluation of the machine learning model subsequent to optimizing the machine learning model using the latency value. For example, a component of the system 100 or a corresponding computer processor can evaluate the model 102 at some point after the model update engine 122 generates one or more updates to optimize the model 102, e.g., after determination of one or more performance thresholds being satisfied or request by user obtained by a processor that implements the final model evaluation 220. The subsequent evaluation can be immediately after optimization or can occur after training the optimized version of the model 102.

In some implementations, performing the evaluation of the machine learning model includes performing (i) accuracy evaluation on the machine learning model, including generating one or more model performance metrics, and (ii) latency evaluation on the machine learning model. For example, one or more model performance metrics can include F1, precision, recall, among others. The accuracy evaluation and the latency evaluation can occur after latency evaluation for temporarily deployed models. For example, the accuracy evaluation and the latency evaluation can occur within the final model evaluation 220 of FIG. 2A.

In some implementations, performing latency evaluation on the machine learning model includes performing latency evaluation on the machine learning model within a processing framework that includes an interface for website input or output and data retrieval from one or more data sources communicably connected to one or more computers operating a website. For example, the latency evaluation after the latency evaluation of the temporarily deployed machine learning model can include latency evaluation of a larger framework that includes input or outputs from a surrounding application or website within which a given model, e.g., the model 102, operates.

In some implementations, optimizing the machine learning model using the latency value includes adjusting one or more of an amount of features, quantization of feature values, or a number of processing layers. For example, the model update engine 122 can generate instructions for a processing element operating one or more processes discussed in regard to FIG. 1 to change one or more of an amount of features, quantization of feature values, or a number of processing layers. Changing the amount of input features can include changing input from including a user browsing history to generate a prediction to not including the user browsing history. Changing quantization of feature values can include changing a number of decimals for a value of the model 102 from 5 floating point values to 4 floating point values to reduce a corresponding memory size of the value. Changing a number of processing layers can include removing or adding a layer within the model 102, where the model 102 includes one or more processing layers that process and provide processed data to subsequent layers or output a response.

In some implementations, optimizing the machine learning model using the latency value includes comparing the latency value as the percentile of the distribution to a threshold latency, determining that the latency value satisfies the threshold latency; and in response to determining that the latency value satisfies the threshold latency, optimizing the machine learning model using the latency value. For example, the model update engine 122 can determine that the 99th percentile of response times for the provided data 114 is above a threshold time, e.g., 100 ms, 200 ms, 30-40 ms, among others. Based on determining the latency of the model 102 deployed in the environment 116 satisfies the threshold, the model update engine 122 can adjust one or more an amount of features, quantization of feature values, or a number of processing layers, among others. The model update engine 122 can generate data indicating latency of the model 102 and provide the indication, e.g., using graphical user interfaces, to a device of a user, e.g., over a network to a device connected to a device implementing operations of the model update engine 122.

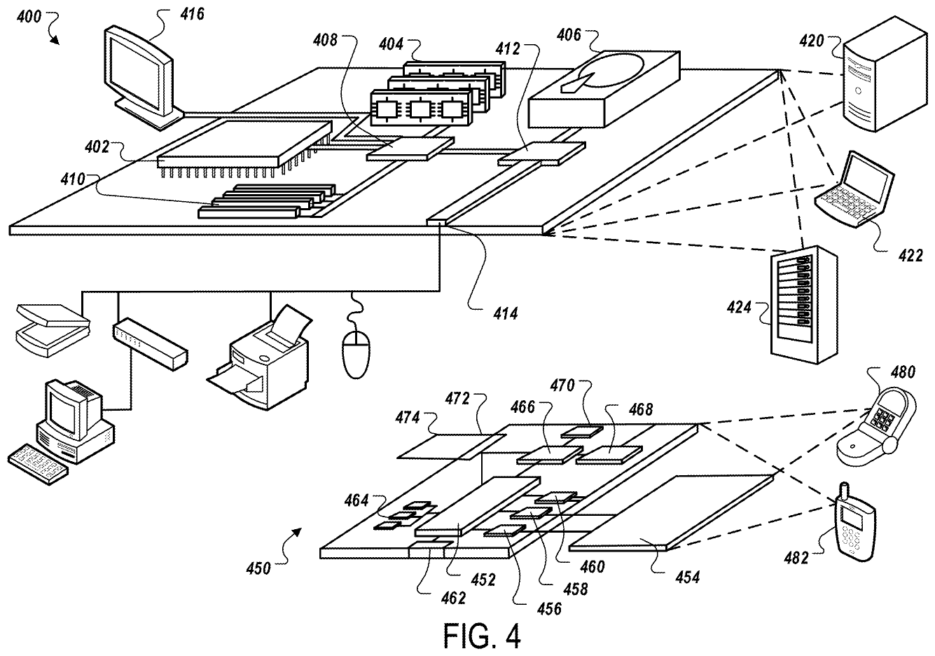

FIG. 4 is a diagram illustrating an example of a computing system used for optimizing a machine learning model. The computing system includes computing device 400 and a mobile computing device 450 that can be used to implement the techniques described herein. For example, one or more components of the system 100 could be an example of the computing device 400 or the mobile computing device 450, such as a computer system implementing the process 300 or operations described in reference to FIG. 1.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method for evaluating latency of a machine learning model during the model training process, the method comprising:
performing, during the model training process, model training for the machine learning model using training data;
in response to performing the model training, generating a temporary deployment of the machine learning model;
providing, as input to the temporarily deployed machine learning model, a portion of the training data including one or more elements;
obtaining, based on processing of the portion of the training data by the temporarily deployed machine learning model, response data indicating output of the temporarily deployed machine learning model;
determining a latency value indicating a processing time for the temporarily deployed machine learning model to generate the response data; and
optimizing the machine learning model using the latency value.

2. The method of claim 1, wherein optimizing the machine learning model using the latency value comprises:
adjusting one or more of an amount of features, quantization of feature values, or a number of processing layers.

3. The method of claim 1, wherein providing, as input to the temporarily deployed machine learning model, the portion of the training data comprises:
generating the training data as a set of serialized machine readable input in a format supported by the temporarily deployed machine learning model.

4. The method of claim 1, comprising:
performing evaluation of the machine learning model subsequent to optimizing the machine learning model using the latency value.

5. The method of claim 4, wherein performing the evaluation of the machine learning model comprises:
performing (i) accuracy evaluation on the machine learning model, including generating one or more model performance metrics, and (ii) latency evaluation on the machine learning model.

6. The method of claim 5, wherein performing latency evaluation on the machine learning model comprises:
performing latency evaluation on the machine learning model within a processing framework that includes an interface for website input or output and data retrieval from one or more data sources communicably connected to one or more computers operating a website.

7. The method of claim 1, wherein determining the latency value indicating the processing time for the temporarily deployed machine learning model to generate the response data comprises:
determining one or more values each indicating a processing time required by the temporarily deployed machine learning model to process an element of the one or more elements of the training data;
generating a distribution from the one or more values each indicating a processing time; and
determining the latency value as a percentile of the distribution.

8. The method of claim 7, wherein the percentile includes the 99^{th} percentile of the distribution.

9. The method of claim 7, wherein optimizing the machine learning model using the latency value comprises:
comparing the latency value as the percentile of the distribution to a threshold latency;
determining that the latency value satisfies the threshold latency; and
in response to determining that the latency value satisfies the threshold latency, optimizing the machine learning model using the latency value.

10. The method of claim 9, wherein the threshold latency is adjustable by a user.

11. The method of claim 10, wherein the threshold latency is less than or equal to 100 milliseconds.

12. The method of claim 1, wherein optimizing the machine learning model using the latency value comprises:
providing a user interface that (i) visualizes the latency value on a display of a user device and (ii) accepts input from a user to adjust one or more features of the machine learning model.

13. The method of claim 1, wherein the machine learning model is configured to provide a ranked list of search output based on a user query.

14. A non-transitory computer-readable medium storing one or more instructions executable by a computer system to perform operations for evaluating latency of a machine learning model during the model training process comprising:
performing, during the model training process, model training for the machine learning model using training data;
in response to performing the model training, generating a temporary deployment of the machine learning model;
providing, as input to the temporarily deployed machine learning model, a portion of the training data including one or more elements;
obtaining, based on processing of the portion of the training data by the temporarily deployed machine learning model, response data indicating output of the temporarily deployed machine learning model;
determining a latency value indicating a processing time for the temporarily deployed machine learning model to generate the response data; and
optimizing the machine learning model using the latency value.

15. The non-transitory computer-readable medium of claim 14, wherein optimizing the machine learning model using the latency value comprises:
adjusting one or more of an amount of features, quantization of feature values, or a number of processing layers.

16. The non-transitory computer-readable medium of claim 14, wherein providing, as input to the temporarily deployed machine learning model, the portion of the training data comprises:
generating the training data as a set of serialized machine readable input in a format supported by the temporarily deployed machine learning model.

17. The non-transitory computer-readable medium of claim 14, wherein the operations comprise:
performing evaluation of the machine learning model subsequent to optimizing the machine learning model using the latency value.

18. The non-transitory computer-readable medium of claim 17, wherein performing the evaluation of the machine learning model comprises:
performing (i) accuracy evaluation on the machine learning model, including generating one or more model performance metrics, and (ii) latency evaluation on the machine learning model.

19. The non-transitory computer-readable medium of claim 18, wherein performing latency evaluation on the machine learning model comprises:
performing latency evaluation on the machine learning model within a processing framework that includes an interface for website input or output and data retrieval from one or more data sources communicably connected to one or more computers operating a website.

20. The non-transitory computer-readable medium of claim 14, wherein determining the latency value indicating the processing time for the temporarily deployed machine learning model to generate the response data comprises:
determining one or more values each indicating a processing time required by the temporarily deployed machine learning model to process an element of the one or more elements of the training data;
generating a distribution from the one or more values each indicating a processing time; and
determining the latency value as a percentile of the distribution.

21. The non-transitory computer-readable medium of claim 20, wherein the percentile includes the 99^{th} percentile of the distribution.

22. A system, comprising:
one or more processors; and
machine-readable media interoperably coupled with the one or more processors and storing one or more instructions that, when executed by the one or more processors, perform operations for evaluating latency of a machine learning model during the model training process comprising:
performing, during the model training process, model training for the machine learning model using training data;
in response to performing the model training, generating a temporary deployment of the machine learning model;
providing, as input to the temporarily deployed machine learning model, a portion of the training data including one or more elements;
obtaining, based on processing of the portion of the training data by the temporarily deployed machine learning model, response data indicating output of the temporarily deployed machine learning model;
determining a latency value indicating a processing time for the temporarily deployed machine learning model to generate the response data; and
optimizing the machine learning model using the latency value.
